(19) United States
(12) Patent Application Publication
(10) Pub. No.: US 2014/0320492 A1
(43) Pub. Date: Oct. 30, 2014

(54) METHODS AND APPARATUS FOR REFLECTIVE SYMMETRY BASED 3D MODEL COMPRESSION

(71) Applicants: Wenfei Jiang, Beijing (CN); Kangying Cai, Beijing (CN); Tao Luo, Beijing (CN)

(72) Inventors: Wenfei Jiang, Beijing (CN); Kangying Cai, Beijing (CN); Tao Luo, Beijing (CN)

(21) Appl. No.: 14/356,668

(22) PCT Filed: Nov. 25, 2011
(86) PCT No.: PCT/CN2011/082985

§ 371 Date: May 7, 2014

(30) Foreign Application Priority Data
Nov. 25, 2011 (WO) PCTCN2011082985

(51) Int. Cl. G06T 17/10; G06T 15/00

(52) U.S. Cl. CPC G06T 17/10; G06T 15/005; G06T 2219/2008
USPC 345/420

(57) ABSTRACT

Encoders and decoders, and methods of encoding and decoding, are provided for rendering 3D images. The 3D images are decomposed by analyzing components of the 3D images to match reflections of patterns in the 3D images, and to restore the components for further rendering of the 3D image. The encoders and decoders utilize principles of reflective symmetry to effectively match symmetrical points in an image so that the symmetrical points can be characterized by a rotation and translation matrix, thereby reducing the requirement of coding and decoding all of the points in 3D image and increasing computational efficiency.

### FIELD OF THE INVENTION

The invention relates to three dimensional (3D) models, and more particularly to transmitting 3D models in a 3D program using reflective techniques to construct rotation and translation matrices for rendering the 3D image.

### BACKGROUND OF THE INVENTION

Large 3D engineering models like architectural designs, chemical plants and mechanical CAD designs are increasingly being deployed in various virtual world applications, such as SECOND LIFE and GOOGLE EARTH. In most engineering models there are a large number of small to medium sized connected components, each having up to a few hundred polygons on average. Moreover, these types of models have a number of geometric features that are repeated in various positions, scales and orientations, such as the meeting room shown in FIG. 1. Such models typically must be coded, compressed and decoded in 3D in order to create accurate and efficient rendering of the images they are intended to represent. The models of such images create 3D meshes of the images which are highly interconnected and often comprise very complex geometric patterns. As used herein, the term 3D models refers to the models themselves, as well as the images they are intended to represent. The terms 3D models and 3D images are therefore used interchangeably throughout this application.

Many algorithms have been proposed to compress 3D meshes efficiently since the early 1990s. See, e.g., J . L. Peng, C. S. Kim and C. C. Jay Kuo, Technologies for 3D Mesh Compression: A survey; ELSEVIER Journal of Visual Communication and Image Representation, 16(6), 688-733, 2005. Most of the existing 3D mesh compression algorithms such as shown in Peng et al. work best for smooth surfaces with dense meshes of small triangles. However, large 3D models, particularly those used in engineering drawings and designs, usually have a large number of connected components, with small numbers of large triangles and often with arbitrary connectivity. The architectural and mechanical CAD models typically have many non-smooth surfaces making the methods of Peng et al. less suitable for 3D compression and rendering.

Moreover, most of the earlier 3D mesh compression techniques deal with each connected component separately. In fact, the encoder performance can be greatly increased by removing the redundancy in the representation of repeating geometric feature patterns. Methods have been proposed to automatically discover such repeating geometric features in large 3D engineering models. See D. Shikhare, S. Bhakar and S. P. Mudur, Compression of Large 3D Engineering Models using Automatic Discovery of Repeating Geometric Features; 6th International Fall Workshop on Vision, Modeling and Visualization (VMV2001), Nov. 21-23, 2001, Stuttgart, Germany. However, Shikhare et al. do not provide a complete compression scheme for 3D engineering models. For example, Shikhare et al. have not provided a solution for compressing the necessary information to restore a connected component from the corresponding geometry pattern. Consideration of the large size of connected components that a 3D engineering model usually comprises leads to the inescapable conclusion that this kind of information will consume a large amount of storage and a great deal of computer processing time for decomposition and ultimate rendering. Additionally, Shikhare et al. only teaches normalizing the component orientation, and is therefore not suitable for discovering repeating features of various scales.

The owner of the current invention also co-owns a PCT application entitled “Efficient Compression Scheme for Large 3D Engineering Models” by K. Cai, Q. Chen, and J. Teng (WO2010149492), which teaches a compression method for 3D meshes that consist of many small to medium sized connected components, and that have geometric features which repeat in various positions, scales and orientations, the teachings of which are specifically incorporated herein by reference. However, this invention requires use of matching criterion that are fairly rigid, have a strong correlation requirement, and therefore a host of components which have similar geometrical features are ignored by this solution.

Thus, the existing techniques ignore the correlation between the pattern and the components that are reflective symmetries of the pattern. As used herein, reflective symmetry refers to a component of the pattern that can be well-matched with a reflection of the pattern. In order to overcome these problems in the art, it would be useful to extend the matching criterion to reflective symmetry and then the components that can be obtained by reflective symmetry transformation may be efficiently represented. This has not heretofore been achieved in the art.

### SUMMARY OF THE INVENTION

These and other problems in the art are solved by the methods and apparatus provided in accordance with the present invention. The invention provides encoders and decoders, and methods of encoding and decoding, which analyze components of the 3D images by matching reflections of patterns in the 3D images and restoring the components for further rendering of the 3D image.

### BRIEF DESCRIPTION OF THE DRAWINGS

FIG. 1 an exemplary 3D model (“Meeting room”) with many repeating features;

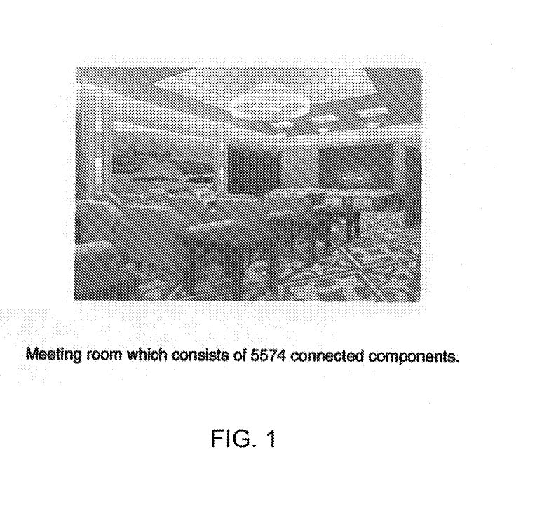

FIG. 2 illustrates a preferred encoder to be used in the CODEC of the present invention;

FIG. 3 illustrates a preferred decoder used in the CODEC of the present invention;

FIGS. 4A and 4B are flow charts of preferred methods of encoding and decoding 3D images, respectively according to the present invention.

FIGS. 5A, 5B and 5C depict a pattern, a rotation of the pattern and a reflection of the pattern, respectively.

### DETAILED DESCRIPTION OF THE PREFERRED EMBODIMENTS

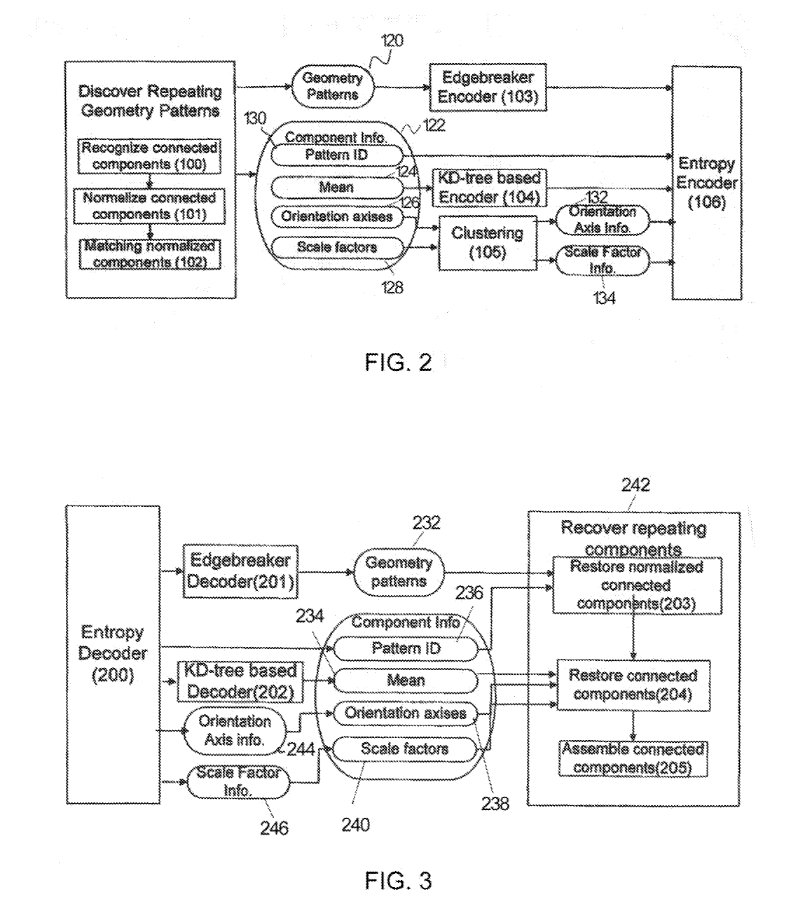

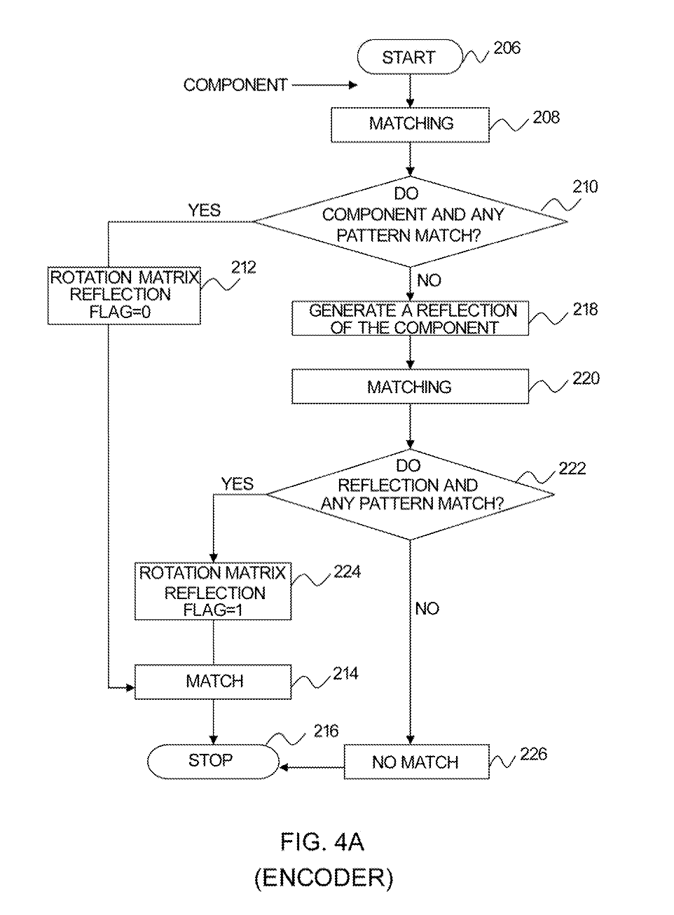

In preferred embodiments, encoders and decoders (“CODECs”) are shown in FIGS. 2 and 3, respectively, which implement the present invention. These CODECs implement a repetitive structure (rotation and reflection) algorithm which effectively represents a transformation matrix including reflection with a simplified translation, three Euler angles and a reflection flag. This allows a pattern or series of patterns to be simplified in order to provide effective 3D coding and decoding of an image, as will be described in further detail below.

Generally, 3D encoding/decoding requires addressing a repetitive structure with quantization of rotation, reflection, translation and scaling, which is denoted “repetitive structure (rotation & reflection & translation & scaling)”. In the past, the art has addressed 3D encoding/decoding by applying repetitive structure (rotation & translation & scaling) analysis without an ability to address reflection properties. The present invention addresses the problem by applying focused repetitive structure (rotation and reflection), which utilizes symmetry properties that allow the encoding/decoding process to be reduced to a repetitive structure (translation and rotation) analysis. As will be appreciated by those skilled in the art, the CODECs of the present invention can be implement in hardware, software or firmware, or combinations of these modalities, in order to provide flexibility for various environments in which such 3D rendering is required. Application specific integrated circuits (ASICs), programmable array logic circuits, discrete semiconductor circuits, and programmable digital signal processing circuits, computer readable media, transitory or non-transitory, among others, may all be utilized to implement the present invention. These are all non-limiting examples of possible implementations of the present invention, and it will be appreciated by those skilled in the art that other embodiments may be feasible.

FIG. 2 shows an encoder for coding 3D mesh models, according to one embodiment of the invention. The connected components are distinguished by a triangle transversal block 100 which typically provides for recognition of connected components. A normalization block 101 normalizes each connected component. In one embodiment, the normalization is based on a technique described in the commonly owned European patent application EP09305527 (published as EP2261859) which discloses a method for encoding a 3D mesh model comprising one or more components. The normalization technique of EP2261859, the teachings of which are specifically incorporated herein by reference, comprises the steps of determining for a component an orthonormal basis in 3D space, wherein each vertex of the component is assigned a weight that is determined from coordinate data of the vertex and coordinate data of other vertices that belong to the same triangle, encoding object coordinate system information of the component, normalizing the orientation of the component relative to a world coordinate system, quantizing the vertex positions, and encoding the quantized vertex positions. It will be appreciated by those with skill in the art that other normalization techniques may be used. Prior uses of the CODECs described herein have provided for normalization of both the orientation and scale of each connected component.

In FIG. 2, block 102 matches the normalized components for discovering the repeated geometry patterns, wherein the matching methods of Shikhare et al. may be used. Each connected component in the input model is represented by the identifier (ID) 130 of the corresponding geometry pattern, and the transformation information for reconstructing it from the geometry pattern 120. The transformation information 122 includes the geometry pattern representative for a cluster, three orientation axes 126, and scale factors 128 of the corresponding connected component(s). The mean 124 (i.e. the center of the representative geometry pattern) is not transmitted, but recalculated at the decoder. An Edgebreaker encoder 103 receives the geometry patterns 120 for encoding. Edgebreaker encoding/decoding is a well-known technique which provides an efficient scheme for compressing and decompressing triangulated surfaces. The Edgebreaker algorithm is described by Rossignac & Szymczak in Computational Geometry: Theory and Applications, May 2, 1999, the teachings of which are specifically incorporated herein by reference. A kd-tree based encoder 10, the provides the mean (i.e. center) of each connected component, while clustering is specifically undertaken at block 105 to produce orientation axis information 132 and scale factor information 138 for ultimate encoding with the transformation information and mean information by an entropy encoder 106.

Similarly, in FIG. 3 the decoder, receives the encoded bit-stream from the encoder and is first entropy decoded 200, wherein different portions of data are obtained. One portion of the data is input to an Edgebreaker decoder 201 for obtaining geometry patterns 232. Another portion of the data, including the representative of a geometry pattern cluster, is input to a kd-tree based decoder 202, which provides the mean 234 (i.e. center) of each connected component. The entropy decoder 200 also outputs orientation axis information 244 and scale factor information 246. The kd-tree based decoder 202 calculates the mean 234, which together with the other component information (pattern ID 236, orientation axes 238 and scale factors 240) is delivered to a recovering block 242. The recovering block 242 recovers repeating components with a first block 203 for restoring normalized connected components, a second block 204 for restoring connected components (including the non-repeating connected components) and a third block 205 for assembling the connected components. In one embodiment, the decoder calculates the mean of each repeating pattern before restoring its instances. In a further block (not shown in FIG. 3), the complete model is assembled from the connected components.

In accordance with the present invention, the repetitive structure (rotation and reflection) techniques of the present invention can be implemented in block 102 of the encoder and block 204 of the decoder. This allows the inventive CODECs to utilize reflective symmetry properties of the present invention to efficiently 3D mesh encode/decode images for further rendering, as described herein. Blocks 102 and 204 provide functionality for analyzing components of the 3D images by matching reflections of patterns in the 3D images and restoring connected components of the images by reflective symmetry techniques as further described herein.

The inventive CODECs are designed to efficiently compress 3D models based on new concepts of reflective symmetry. In the reflective symmetry techniques which the inventors have discovered, the CODECs check if components of an image match the reflections of patterns in the image. Thus, coding redundancy is removed and greater compression is achieved with less computational complexity. The inventive CODECs do not require complete matching of the components to the patterns in the image or the reflections of the patterns in the image.

Reflective symmetry in accordance with the present invention approaches 3D entropy encoding/decoding in three broad, non-limiting ways. First, the CODEC tries to match the components of the 3D models with the reflections of the patterns as well as the patterns themselves. Second, the transformation from the pattern to the matched component is decomposed into the translation, the rotation, and the symmetry/repetition flag, wherein the rotation is represented by Euler angles. Third, the symmetry of every pattern is checked in advance to determine whether it is necessary to implement reflective symmetry detection. If the pattern is symmetric itself, the complexity cost of reflective symmetry detection and the bit cost of the symmetry/repetition flag are saved.

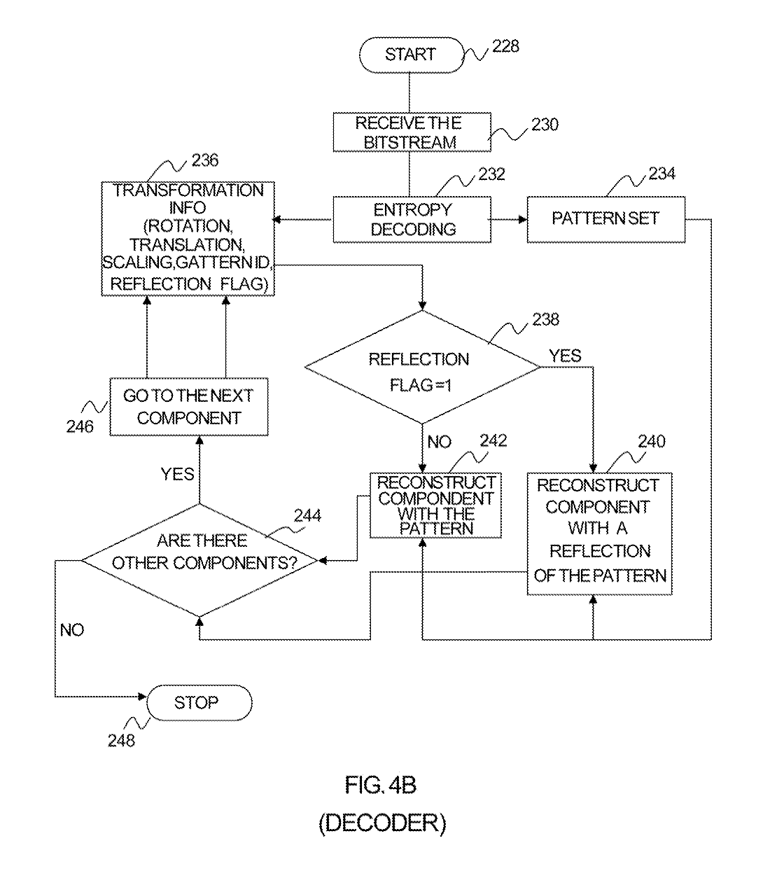

Referring now to FIG. 4A, methods of encoding 3D images in accordance with the invention start at step 206 as will be discussed in more detail. Matching of any of the patterns to the component begins at step 208, and at step 210 it is first determined whether any of the components match any of the patterns in the image. If so, then at step 212 the rotation matrix is generated and the reflection flag is set to “0” and it has been determined at step 214 that the pattern matches the component and the method can stop at step 216.

If it is determined at step 210 that the component does not match any of the patterns then at step 218, a reflection of the component is generated, and matching in accordance with the invention again undertaken at 220. At step 222, it is then determined whether the any of the patterns match the reflection of the component. If not, then no matching is possible at step 226 and the method stops at step 216. If so, then at step 224 the rotation matrix is generated and the reflection flag is set to “1”. A match has then been determined at step 214, and the method stops at step 216. It will be appreciated that this process can be undertaken for multiple components, as is necessary to encode a complex 3D image.

At this point the bitstream with 3D image parameters has been encoded, and is sent to the decoder of FIG. 4B. The bitstream with the pattern data is received at step 230, and at step 232 the data is entropy decoded to produce a pattern set of the data which is stored in memory at step 234. The entropy decoding step 232 also decomposes the transformation information at step 236 including the rotation data, translation data, scaling data, pattern ID, and the reflection flag which has been set to 1 or 0.

It is then determined at step 238 whether the reflection flag has been set to 1. If not, then the flag is 0 and at step 242 the pattern is reconstructed with the component. At step 244, it is then determined whether there are other components in the pattern to be matched and reconstructed and if not, then the method stops at step 248. If so, then at step 246 the next component is utilized and the process repeats from step 236.

If at step 238 the reflection flag is 1 and at step 240 the reflection of the pattern is reconstructed with the component and the method moves on to step 244. At step 244 it is determined whether there are other components as before and if not, the method stops at step 248. Otherwise, at step 246 the next component is utilized and the method is repeated from step 236. At this point, the 3D image is completely reconstructed in accordance with the invention by reflective symmetry, which has not heretofore been achieved in the art.

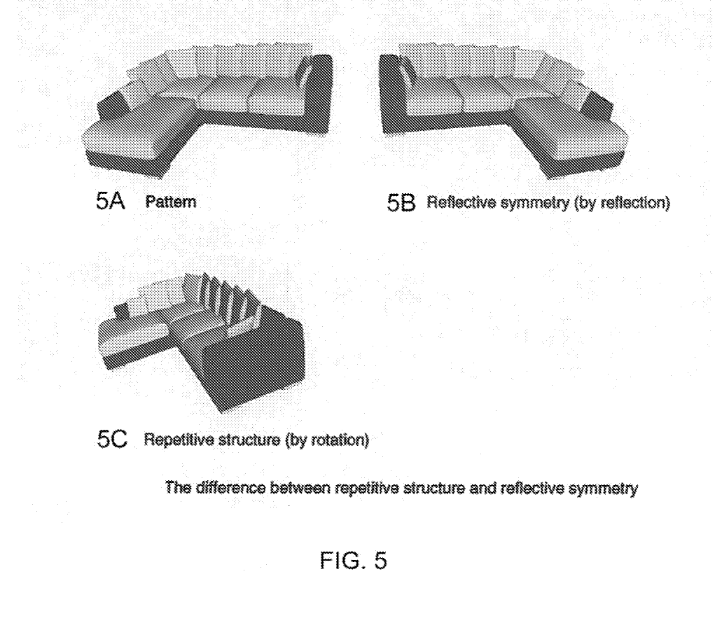

In order to implement the reflective symmetry discoveries of the present invention as set forth with respect to the methods of the flow charts of FIG. 4A and FIG. 4B, referring now to FIG. 5C the repetitive structure is defined as the component that can be obtained by rotation and translation of the pattern. When such components are detected, for example in the above-referenced WO2010149492 and as was previously accomplished by the encoder of FIG. 2 and decoder of FIG. 3, they have been represented by the translation vector, the rotation matrix and the pattern ID rather than the actual geometry information. Unfortunately, this requires that the repetitive structure exactly matches the pattern, which means that the components of a reflected pattern, such as shown FIG. 5B, cannot be represented. However, since the components in FIG. 5B are nearly identical to the pattern in FIG. 5A, it is computationally duplicative, and therefore concomitantly expensive, to re-encode the geometry of FIG. 5B.

To alleviate this unnecessary computational complexity and expense, the inventors have discovered that these components can be obtained by the reflection of the pattern rather than by rotation and/or translation alone. This is accomplished by denoting the vertices of the pattern or candidate component by an n×3 matrix, wherein each column represents a vertex and n is the number of the vertices. The translation vector of components is not considered for simplicity, i.e., all the components discussed below are translated to the origin, although it will be appreciated by those with skill in the art that other than the origin of the reference frame may be used and that in such cases a translation of the points would be necessary. Either of these possibilities is within the scope of the present invention.

Suppose the pattern is

$$P = [ \begin{matrix}{x}_{1} & {x}_{2} & {x}_{3} & & {x}_{n} \\ {y}_{1} & {y}_{2} & {y}_{3} & … & {y}_{n} \\ {z}_{1} & {z}_{2} & {z}_{3} & & {z}_{n}\end{matrix} ] ,$$

while the candidate component is

$$C = [ \begin{matrix}{u}_{1} & {u}_{2} & {u}_{3} & & {u}_{n} \\ {v}_{1} & {v}_{2} & {v}_{3} & … & {v}_{n} \\ {w}_{1} & {w}_{2} & {w}_{3} & & {w}_{n}\end{matrix} ] .$$

If the component can be obtained by a rotation of the pattern, there must exist a 3×3 rotation matrix

$$\begin{matrix}R = [ \begin{matrix}{a}_{1} & {b}_{1} & {c}_{1} \\ {a}_{2} & {b}_{2} & {c}_{2} \\ {a}_{3} & {b}_{3} & {c}_{3}\end{matrix} ] \\ = [ \begin{matrix}\vec{a} & \vec{b} & \vec{c}\end{matrix} ]\end{matrix}$$

that satisfies the following conditions:

a) C=RP.

b) ∥\vec{a}∥=1, ∥\vec{b}∥=1, ∥\vec{c}∥=1 (1)

c) \vec{a}·\vec{b}=0 (2)

d) \vec{a}×\vec{b}=\vec{c} (3)

In this invention, eight reflective symmetries of the pattern are generated first by reflections.

$${S}_{ijk} = {{{[ \begin{matrix}- 1 & 0 & 0 \\ 0 & 1 & 0 \\ 0 & 0 & 1\end{matrix} ]}^{i} [ \begin{matrix}1 & 0 & 0 \\ 0 & - 1 & 0 \\ 0 & 0 & 1\end{matrix} ]}^{j} [ \begin{matrix}1 & 0 & 0 \\ 0 & 1 & 0 \\ 0 & 0 & - 1\end{matrix} ]}^{k}$$

$${P}_{ijk} = {S}_{ijk} P \\ ( i , j , k = 0 or 1 )$$

The original pattern is P₀₀₀. It is reflective symmetry transformed with respect to the x axis when i equals 1. Similarly, it is reflected with respect to the y (z) axis when j (k) equals 1.

As long as the candidate component can be obtained by the rotation of any of the eight reflective symmetries of the pattern (i.e., C=RPᵢⱼₖ), it can be represented by the translation vector, the rotation matrix, the pattern ID and the reflective symmetry index. Then the components such as shown in FIG. 5B can be efficiently compressed.

To represent the rotation matrix it is not necessary that all the elements be encoded, since they are not independent. In a preferred embodiment, the Euler angle representation is utilized, i.e., the rotation matrix R is represented by three Euler angles θ, Φand

$$ψ ( - \frac{π}{2} < θ \leq \frac{π}{2} , - π < Φ , ψ \leq π ) .$$

```
if a₃ ≠ ±1
  $\begin{matrix}θ = - {sin}^{- 1} {a}_{3} \\ ψ = tan {2}^{- 1} ( \frac{{b}_{3}}{cos θ} , \frac{{c}_{3}}{cos θ} ) \\ Φ = tan {2}^{- 1} ( \frac{{a}_{2}}{cos θ} , \frac{{a}_{1}}{cos θ} )\end{matrix}$
else
  Φ = anything; can set to 0
  if a₃ = −1
    $\begin{matrix}θ = \frac{π}{2} \\ ψ = Φ + tan {2}^{- 1} ( {b}_{1} , {c}_{1} )\end{matrix}$
  else
    $\begin{matrix}θ = - \frac{π}{2} \\ ψ = - Φ + tan {2}^{- 1} ( - {b}_{1} , - {c}_{1} )\end{matrix}$
  end if
end if
```

θ, Φ and ψ are quantized and encoded instead of the 9 elements of the rotation matrix.

To recover the rotation matrix R,

$$R = [ \begin{matrix}cos θcosΦ & sin ψsinθcosΦ - cos ψsinΦ & cos ψsinθcosΦ + sin ψsinΦ \\ cos θsinΦ & sin ψsinθsinΦ + cos ψcosΦ & sin ψsinθsinΦ - cos ψsinΦ \\ - sin Φ & sin ψcosθ & cos ψcosθ\end{matrix} ]$$

This approach works only if the matrix satisfies Eq. (1)˜(3), which is why directly compressing the product of the rotation matrix and reflection matrix, RSᵢⱼₖ cannot be achieved.

If the candidate component satisfies C=RPᵢⱼₖ, it is regarded as a repetitive structure or a reflective symmetry of the pattern and it is necessary to derive a specification of which reflection of the pattern matches the component. In a preferred embodiment, a 3-bit flag is used to denote the 8 combination of i, j and k. However, it is unnecessary to specify each case.

Two reflective symmetry transformations are equivalent to a certain rotation. Therefore, if mod(i+j+k, 2)=0 Sᵢⱼₖ can be a regarded as a rotation matrix itself; otherwise, if mod(i+j+k, 2)=1, it can be decomposed into one rotation matrix H and one reflection matrix G, Sᵢⱼₖ=HG.

It is further preferred to specify that

$$G = [ \begin{matrix}1 & 0 & 0 \\ 0 & 1 & 0 \\ 0 & 0 & - 1\end{matrix} ] .$$

So Sᵢⱼₖ is rewritten as:

$${S}_{ijk} = {H [ \begin{matrix}1 & 0 & 0 \\ 0 & 1 & 0 \\ 0 & 0 & - 1\end{matrix} ]}^{k}$$

Example 1: if i=1, j=1, k=0,

$$\begin{matrix}{S}_{110} = [ \begin{matrix}- 1 & 0 & 0 \\ 0 & 1 & 0 \\ 0 & 0 & 1\end{matrix} ] [ \begin{matrix}1 & 0 & 0 \\ 0 & - 1 & 0 \\ 0 & 0 & 1\end{matrix} ] \\ = {[ \begin{matrix}- 1 & 0 & 0 \\ 0 & - 1 & 0 \\ 0 & 0 & 1\end{matrix} ] [ \begin{matrix}1 & 0 & 0 \\ 0 & 1 & 0 \\ 0 & 0 & - 1\end{matrix} ]}^{0} .\end{matrix}$$

$$Thus , \\ H = [ \begin{matrix}- 1 & 0 & 0 \\ 0 & - 1 & 0 \\ 0 & 0 & 1\end{matrix} ] , \\ k = 0.$$

Example 2: if i=0, j=1, k=0,

$$\begin{matrix}{S}_{010} = [ \begin{matrix}1 & 0 & 0 \\ 0 & - 1 & 0 \\ 0 & 0 & 1\end{matrix} ] \\ = [ \begin{matrix}1 & 0 & 0 \\ 0 & - 1 & 0 \\ 0 & 0 & - 1\end{matrix} ] [ \begin{matrix}1 & 0 & 0 \\ 0 & 1 & 0 \\ 0 & 0 & - 1\end{matrix} ] ,\end{matrix}$$

$$Thus , \\ H = [ \begin{matrix}1 & 0 & 0 \\ 0 & - 1 & 0 \\ 0 & 0 & - 1\end{matrix} ] , \\ k = 1$$

It can be seen that the matrices H in Example 1&2 satisfy Eq. (1)˜(3)

Thus, H indicates a rotation and can be combined with the rotation matrix R, obtaining matrix R_{S}.

$$\begin{matrix}C = {RP}_{ijk} \\ = {RS}_{ijk} P \\ = {RH [ \begin{matrix}1 & 0 & 0 \\ 0 & 1 & 0 \\ 0 & 0 & - 1\end{matrix} ]}^{k} P \\ = {{R}_{S} [ \begin{matrix}1 & 0 & 0 \\ 0 & 1 & 0 \\ 0 & 0 & - 1\end{matrix} ]}^{k} P\end{matrix} \qquad ( 4 )$$

To simplify reflective symmetry detection it is useful to recognize that it is unnecessary to compare the candidate component with all the eight reflections of the pattern.

As shown in Eq. (4),

$$\begin{matrix}{P}_{ijk} = {S}_{ijk} P \\ = {H [ \begin{matrix}1 & 0 & 0 \\ 0 & 1 & 0 \\ 0 & 0 & - 1\end{matrix} ]}^{k} P ,\end{matrix}$$

which means any of the eight reflections can be represented by a rotation H of the pattern, or a rotation of the reflection with respect to the z axis. More specifically, if the pattern is symmetric itself, any of the eight reflections can be obtained by a rotation.

Therefore, in a preferred embodiment of the present methods, the repetitive structures and reflective symmetry detection is implemented as follows. Compare the candidate component with the pattern. If they are well-matched, derive the rotation matrix; else, generate a reflection of the pattern with respect to the z axis, obtaining

$${P}_{001} = [ \begin{matrix}1 & 0 & 0 \\ 0 & 1 & 0 \\ 0 & 0 & - 1\end{matrix} ] P .$$

Compare the candidate component with the reflection P₀₀₁. If they are well-matched, derive the rotation matrix; else, the candidate component cannot be a repetitive structure or a reflective symmetry.

The encoding/decoding methods utilize the existing patterns to represent the components of the 3D model. For each component, the CODEC compares it to all the patterns. If the component matches one of the patterns, the translation vector, the rotation matrix, the pattern ID and a flag for symmetry/repetition are encoded to represent the component. Actually in Eq. (4), the symmetry/repetition flag is the value of k, and the rotation matrix is R_{S}. The following focuses on the compression of the components.

The symmetry of every pattern is checked to decide whether it is necessary to generate a reflection. Each pattern is compared (and its reflection if necessary) with the component. If one of the patterns (or its reflection) matches the component, the symmetry/repetition flag is set to 0; otherwise, if one of the reflection of the patterns matches the component, the flag is set to 1. The translation vector, the pattern ID and the symmetry/repetition flag are encoded with existing techniques and the rotation matrix is compressed as discussed above.

In such fashion a 3D mesh image can be efficiently and cost-effectively generated from an image with reflective symmetry properties. This allows a complicated image with a reflective set of patterns to be coded and decoded using rotation and translation, which greatly reduces the encoding/decoding problem to a known set of parameters. Such results have not heretofore been achieved in the art.

1. A method of decoding a 3D image, comprising the steps of:
decoding components of a received bitstream containing 3D components of the image to obtain pattern set of the 3D image;
decomposing the components into translation, rotation and reflection information of the pattern;
checking a parameter to determine if the pattern may be matched to the components; and
reconstructing the image using the component and the pattern set with a decoded rotation matrix of the pattern.

2. The method of claim 1, further comprising the step of reconstructing the 3D model using a reflection of the pattern when the parameter is set such that the pattern is not matched to the component, wherein the decomposing step further comprises the step of generating a plurality of reflected points in the image pattern to characterize the matched components.

3. The method recited in claim 2, further comprising the step of deriving a rotation matrix when either the pattern matches the component, or the reflection matches the component.

4. The method recited in claim 3, wherein the decoding step comprises a step of entropy decoding the components.

5. The method recited in claim 4, further comprising the step of incrementing a component for further pattern matching until all components are matched.

6. The method recited in claim 5, wherein the reflection information comprises a reflection flag.

7. The method recited in claim 6, further comprising the step of examining the reflection flag to determine if the pattern is to be matched to the component or a reflection of the pattern is to be matched to the component.

8. A decoder for decoding 3D images, comprising a circuit for analyzing components of the 3D images by matching reflections of patterns in the 3D images and restoring the components for further rendering of the 3D image.

9. The decoder recited in claim 8, wherein the circuit further comprises circuitry for decomposing the matched components into translation, transformation, scaling and reflection components.

10. The decoder recited in claim 9, wherein circuit further comprises circuitry for determining whether the pattern matches the component, or the reflection of the pattern matches the component.

11. The decoder recited in claim 10, wherein the decomposing circuitry further comprises circuitry for decomposing a rotation matrix to obtain the transformation, rotation, scaling and symmetry components.

12. The decoder recited in claim 11, wherein the symmetry component comprises a reflection flag.

13. A method of encoding a 3D image, comprising the steps of:
encoding the 3D image to obtain at least one pattern representing components of the 3D image;
for each component of the 3D image, comparing the component to the pattern to determine whether the component matches the pattern;
when the component matches the pattern, encoding parameters related to the component to obtain an encoded represented component; and
setting a reflection flag to a value to indicate that the pattern matches the component.

14. The method recited in claim 13, wherein the step of encoding parameters comprises the step of generating a transformation matrix to obtain translation, rotation and scaling factors related to the pattern.

15. The method of claim 14 setting the reflection flag to 0 if the pattern matches the component.

16. The method of claim 15, further comprising the step of setting the reflection flag to 1 if the reflection of the pattern matches the component.

17. The method of claim 16, wherein the encoding step comprises entropy encoding the 3D image.

18. An encoder for encoding a 3D image comprising:
an entropy encoder for obtaining at least one pattern representing components of the 3D image;
circuitry for comparing the component to the pattern to determine whether the component matches the pattern; and
circuitry for encoding parameters related to the component to obtain an encoded represented component and setting a reflection flag to a value to indicate that the pattern matches the component.

19. The encoder recited in claim 18, wherein the circuitry for encoding parameters further comprises circuitry for generating a transformation matrix to obtain translation, rotation and scaling factors related to the pattern.

20. The encoder recited in claim 19, further comprising circuitry for setting the reflection flag to 0 if the pattern matches the component and setting the reflection flag to 1 if the reflection of the pattern matches the component.
